(19) United States
(12) Patent Application Publication
(10) Pub. No.: US 2003/0074243 A1
(43) Pub. Date: Apr. 17, 2003

(54) System for promoting engineer capability for issue solutions

(75) Inventor: Mei-Ling Po, Kaohsiung city (TW)

Correspondence Address: DOUGHERTY & TROXELL, SUITE 1404, 5205 LEESBURG PIKE, FALLS CHURCH, VA, 22041, US

(73) Assignee: Advanced Semiconductor Engineering, Inc.

(21) Appl. No.: 09/978,039

(22) Filed: Oct. 17, 2001

(51) Int. Cl. G06F 17/60

(52) U.S. Cl. 705/7

(57) ABSTRACT

A system is disclosed for a user of an organization to promote engineer capability of issue solution comprising an expert system processing request transmitted by a user, a training center is coupled to the expert system to provide training materials and programs. A solution model database is coupled to the expert system for the user to access solution example, thereby increasing the capability of solving problem. A technical document center is coupled to the expert system for storing technical literatures. An engineer query system is coupled to the expert system for the user to search any process data and information. Customer presentation material is coupled to the expert system and a project management system is connected to the expert system to help the user to build new action solutions.

### FIELD OF THE INVENTION

The present invention relates to a system for promoting engineer capability for issue solution via a communication network.

### BACKGROUND OF THE INVENTION

Modern network systems must allow computers to electronically communicate with each other in order to ensure shared transmission and manipulation of information. The communication is improved and driven by the development of the technology and the broadband network increases the transmission rate. For example, the broadband network with 1.5 Mbps bandwidth can replace the function of the current used telephone transmission. The integration trend of the network and the wireless transmission will provide the availability of communication without the limitation of geography area. Rapid development of the network has enabled computer systems to provide an efficient, widely accessible, and secure mechanism for utilizing the resource of database. By connecting most computer systems, the network allows users to interact with other computer terminal by using a center server. The system allows individuals to communicate with each other by linking a computer system with the network.

In order to maintain the resource of a company, database is always used to store all materials generated by the company including technique materials, issue solutions and so on. However, some of the items may be lost due to the employee switches one's position to another company. Occasionally, the know-how and issue solution are also gone with them. Therefore, the organization has to train the fresh persons to handle the issue from the beginning. If all the know-how and key information may be maintained in database of the company, then the cost will be reduced.

Further, a system is also needed to maintain the database and to promote engineering capability for issue solution. By the usage of the system, the training cycle will be scaled down and the engineer may reach the solution created by the former person. Thus, there is a need to shorten the learning time of a new operator or engineer.

### SUMMARY OF THE INVENTION

Base on the previous discussion, the object of the present invention is to provide a system for an employee to reach the solution of all issue by himself via a communication network.

A system is disclosed for a user of an organization to promote engineer capability of issue solution comprising an expert system, a training center, a solution model database, a technical document center and an engineer query system. The expert system is applied to process requests transmitted by a user. The training center for storing training materials and programs is responsive to the expert system to provide some suitable training materials and programs for the user. The solution model database for storing solution models is responsive to analyses and judgements of the expert system to provide some solution models for the user, thereby increasing the capability of solving problem. The technical document center for storing technique literatures is responsive to controls of the expert system to provide some data to the user. And the engineer query system is coupled to the expert system for providing said user to search any process data and information.

### BRIEF DESCRIPTION OF THE DRAWINGS

FIG. 1 is a functional diagram of the system according to the present invention.

### DETAILED DESCRIPTION

The present invention discloses a system that provides the solution and training program for the user of an organization to promote engineer capability for issue solution. Therefore, the user may obtain the solutions via a network and the user may shorten the learning cycle through the network. The system serves as a central control system to send information to the user, the system receives the information from the user and process the request, then informs the result to the user.

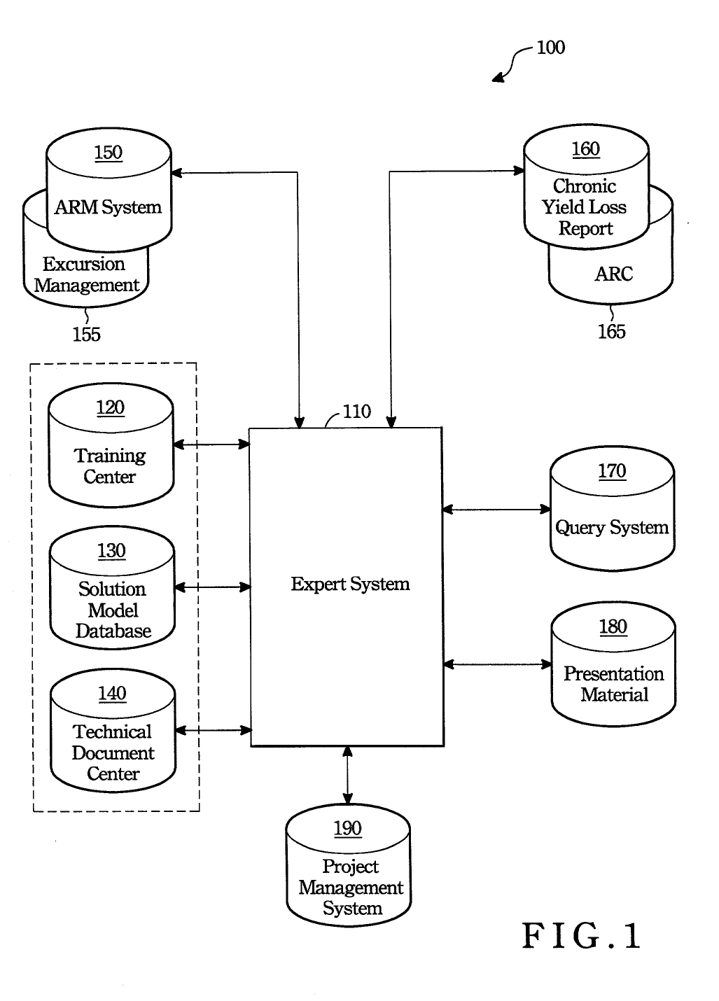

The present invention can be implemented using a computer with a display screen and a positional input device. With reference to the FIG. 1, there is illustrated a block diagram of the architecture of the system 100 to promote engineer capability for issue solution according to the present invention. An expert system 110 processes the request transmitted from the user. The expert system 110 provides a platform for executing requests from the user to perform judging and analyzing functions, and then to retrieve problem solution procedure and solution tools to the user. The expert system 110 has a database in which includes the know-how material, technical features, index, catalog and the solution for each standard procedure of each stage. It also provides the past experience for reference. Thus the platform of the expert system 110 can perform the identifying, judging, and explaining steps according to the fields chosen by the user.

A training center 120, solution model database 130 and technical document center 140 are respectively coupled to the expert system 110 to respond the expert system 110 and provide needed information to the user. The training center 120 is applied to store all the training materials and programs about the company. And the training center 120 is responsive to the guidance and recommendation of the expert system 110 to provide proper materials and programs for the user. For example, the training center 120 can provide materials such as manufacturing processes, technical backgrounds, machine data and operating manuals to help a fresh engineer to perform self-training himself. Thus the cycle time for training an engineer can be shortened.

Besides, the solution model database 130 includes the solution model for the user to access the solution example, thereby increasing the capability of solving problem of the user. When the user input issues, the expert system can judge and guide real-time the solution model. The document center 140 is applied to store the related technical literature, science papers, periodicals, meeting records, etc. and can provide data for the user under controls of the expert system 110.

It is noted that the expert system 110 is associated with management systems fro the purpose of promoting using efficiency of company resources. The action request from management system (ARM) 150 is responsive to the action requests of management departments via the expert system 110 to provide suitable solution to the user, thereby reducing the cost to debug and improving the capability to solve any process issue. The ARM system 150 includes an excursion management database 155 to maintain past extraordinary matter and related solution. Thus the user can find the some action basis for the unusual issues.

Further a chronic yield loss report system 160 is coupled to the expert system 110. And the system 160 includes an action request from customer (ARC) system 165. The Chronic yield loss report system 160 is applied to analyze the level of the manufacture quality and then to generate the analysis report to show throughputs, yields, specifications and parameters of various products. The chronic yield loss report system 160 is also connected to the customer service unit that responses the request from the customer. The ARC 165 is applied to maintain the record of customer service and detail of the service procedure, therefore the ARC 165 may provide excellent interface between the service provider and the client.

An engineer query system 10 is also coupled to the expert system 110 for the engineer to search any process data and information via the query system 170. The expert system 110 is responsive to the keywords input by the user to perform the analyzing and judging functions for reaching the suitable information. Therefore the fresh engineer may train himself via the system 170, and this system can shorten the time for training an engineer. Further, customer presentation material database 180 is also coupled to the expert system 110 to illustrate the exhibition materials and reports responsive to requests of consumers.

Specifically when the ARM 150 can not find action solutions suitable for the user, the expert system 110 will connect to a project management system 190 for generating new action solutions by integrating the principles and methods stored in the project management system 190. And the action solutions generated according to the project management system 190 is then fed to the technical document center 140. Similarly when the consumers and the consumer service department can not obtain suitable action solutions from the ARC 165, the expert system 110 can proceed the analyzing and estimating functions to generate related solutions.

During operation, the system 110 receives the requested issue and judges the issue exits in the action database or not? The request is send from the ARM, user or the ARC. If the requested is already created in the system, the system will fetch the related material for the user. If the requested issue is not already in the database, the expert system 110 may access similar solution for the user. The user may search related material or solution from each database via the expert system 110.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A system for providing solution and training program for a user of an organization to promote engineer capability of issue solutions comprises:
an expert system processing requests transmitted by a user to perform analyzing and judging functions for retrieving solutions and tools for said user;
a training center for storing training materials and programs, responsive to said expert system to provide some suitable training materials and programs for said user;
a solution model database for storing solution models, responsive to analyses and judgements of said expert system to provide some solution models for said user, thereby increasing the capability of solving problem of said user;
a technical document center for storing technical literatures, responsive to controls of said expert system to provide some data to said user; and
an engineer query system coupled to said expert system for providing said user to search any process data and information.

2. The system of claim 1, wherein said training materials of said training center comprise manufacturing processes, technical backgrounds, machine data and operating manuals.

3. The system of claim 1, wherein further comprises an action request from management system coupled to said expert system, responsive to action requests of management departments to provide suitable solutions to said user, thereby reducing the cost to debug and improving the capability of said user to solve any process issue.

4. The system of claim 3, wherein said action request from management system further comprises an excursion management database to store past extraordinary matters and related solutions.

5. The system of claim 3, wherein further comprises a project management system responsive to said expert system to generate new action solutions by integrating the principles and methods therein when there is no suitable action solutions for said user.

6. The system of claim 5, wherein said new action solutions is then updated and stored in said project management system and fed to said technical document center under controls of said expert system.

7. The system of claim 1, wherein further comprises a chronic yield loss report system coupled to said expert system to analyze levels of manufacture quality and then generate analysis reports to illustrate throughputs, yields, specifications and parameters of products.

8. The system of claim 7, wherein said chronic yield loss report system is connected to a customer service unit to provide said throughputs, yields, specifications and parameters according to requests of customers.

9. The system of claim 7, wherein said chronic yield loss repost system further comprises an action request from the customer system to maintain the records of customer services and details of service procedures.

10. The system of claim 9, wherein further comprises a project management system responsive to said expert system to generate new action solutions by integrating the principles and methods therein when there is no suitable action solutions for said user.

11. The system of claim 1, wherein further a customer presentation material database coupled to said expert system to provide materials of exhibitions and reports according to requests of customers.
